(19) United States
(12) Patent Application Publication
(10) Pub. No.: US 2026/0120253 A1
(43) Pub. Date: Apr. 30, 2026

(54) METHOD OF REMOVING NOISE FROM IMAGE, COMPUTER PROGRAM THEREFOR, AND IMAGE PROCESSING DEVICE

(71) Applicant: HANWHA VISION CO., LTD., Seongnam-si (KR)

(72) Inventor: Eun Cheol CHOI, Seongnam-si (KR)

(73) Assignee: HANWHA VISION CO., LTD., Seongnam-si (KR)

(21) Appl. No.: 19/195,278

(22) Filed: Apr. 30, 2025

(30) Foreign Application Priority Data
Oct. 29, 2024 (KR) 10-2024-0149769

(51) Int. Cl. G06T 5/70; G06T 5/50; G06T 7/215

(52) U.S. Cl. CPC G06T 5/70; G06T 5/50; G06T 7/215; G06T 2207/20182; G06T 2207/30196

(57) ABSTRACT

A method of removing noise from an image may include generating a first output frame by removing noise from a first motion area in a first frame, and removing noise from a first remaining area obtained by excluding the first motion area from the first frame, wherein the first motion area is determined based on a comparison between the first frame and a second frame that is a frame before the first frame, and generating a second output frame by removing noise from a second motion area in the first output frame, determined based on a comparison between the first output frame and a background frame, and removing noise from a second remaining area obtained by excluding the second motion area from the first output, wherein the second motion area is determined based on a comparison between the first output frame and a background frame.

### CROSS-REFERENCE TO RELATED APPLICATION

This application is based on and claims priority from Korean Patent Application No. 10-2024-0149769, filed on Oct. 29, 2024, in the Korean Intellectual Property Office, the disclosure of which is herein incorporated by reference in its entirety.

### BACKGROUND

### 1. Field

One or more example embodiments of the disclosure relate to a method of removing noise from an image by using spatiotemporal information, and more particularly, to a method of removing noise from an image by using correlation between consecutive frames.

### 2. Description of Related Art

In a general spatiotemporal noise reduction method, spatial noise reduction (SNR) is applied to a motion area, temporal noise reduction (TNR) is applied to a non-motion area, and an appropriate mix of SNR and TNR described above is applied until TNR is fully applied after motion occurs.

In such a method, while noise can be effectively removed from an image, image quality may deteriorate because a result of SNR is partially used until TNR is fully applied after motion occurs.

In particular, an SNR application ratio remains high for an image in which an object passes, and thus, deterioration of image quality, such as noise trailing, occurs. In environments with sufficient light, the effect of noise is small and an effect of noise trailing on image quality may be inappreciable. However, in environments with low light, in which sensor gain is high, a significant deterioration in image quality is observed due to noise trailing.

### SUMMARY

One or more example embodiments of the disclosure are provided to solve problems in a spatiotemporal noise reduction method described above, in particular, to effectively improve deterioration of image quality occurring due to noise trailing or the like in a low illuminance environment.

According to an aspect of an example embodiment of the disclosure, a method of removing noise from an image includes generating a first output frame by removing a noise from a first motion area in a first frame, and removing a noise from a first remaining area, obtained by excluding the first motion area from the first frame, wherein the first motion area is determined based on a comparison between the first frame and a second frame that is a frame before the first frame; and generating a second output frame by removing a noise from a second motion area in the first output frame, and removing a noise from a second remaining area, obtained by excluding the second motion area from the first output frame, wherein the second motion area is determined based on a comparison between the first output frame and a background frame.

According to an aspect of an example embodiment of the disclosure, a non-transitory computer-readable medium stores a computer program, wherein the computer program, when executed by at least one processor, causes the at least one processor to perform: generating a first output frame by a removing noise from a first motion area in a first frame, and removing a noise from a first remaining area, obtained by excluding the first motion area from the first frame, wherein the first motion area is determined based on a comparison between the first frame and a second frame that is a frame before the first frame; and generating a second output frame by removing a noise from a second motion area in the first output frame, and removing a noise from a second remaining area, obtained by excluding the second motion area from the first output frame, wherein the second motion area is determined based on a comparison between the first output frame and a background frame.

According to an aspect of an example embodiment of the disclosure, an image processing device includes at least one processor, wherein the at least one processor may be configured to: generate a first output frame by removing a noise from a first motion area in a first frame, and removing a noise from a first remaining area, obtained by excluding the first motion area from the first frame, wherein the first motion area is determined based on a comparison between the first frame and a second frame that is a frame before the first frame; and generate a second output frame by removing a noise from a second motion area in the first output frame, and removing a noise from a second remaining area, obtained by excluding the second motion area from the first output frame, wherein the second motion area is determined based on a comparison between the first output frame and a background frame.

Other aspects, features, and advantages than those described above will become apparent from the following drawings, claims, and detailed description of the disclosure

### BRIEF DESCRIPTION OF DRAWINGS

These and/or other aspects will become apparent and more readily appreciated from the following description of example embodiments, taken in conjunction with the accompanying drawings in which:

FIG. 1 is a schematic diagram showing a configuration of an image processing device according to an embodiment;

FIG. 2 is a view for describing a structure of an image processed by an image processing device;

FIG. 3 is a view showing an example of a motion area;

FIG. 4 is a view showing an example of an example of a remaining area;

FIG. 5 is a view showing sizes of masks used for comparing two frames according to an embodiment;

FIG. 6 is a view for explaining a first noise removing method and a third noise removing method of an image processing device according to an embodiment;

FIG. 7 is a view for explaining a second noise removing method and a fourth noise removing method of an image processing device according to an embodiment;

FIG. 8 is a view for explaining a process, performed by an image processing device, of generating an accumulated frame according to an embodiment; and

FIG. 9 is a flowchart for explaining a method used by an image processing device to remove noise from an image, according to an embodiment.

### DETAILED DESCRIPTION

Reference will now be made in detail to embodiments, examples of which are illustrated in the accompanying drawings. In this regard, the present embodiments may have different forms and should not be construed as being limited to the descriptions set forth herein. Accordingly, the embodiments are merely described below, by referring to the figures, to explain aspects of the present description.

As used herein, the term “and/or” includes any and all combinations of one or more of the associated listed items. Expressions such as “at least one of,” when preceding a list of elements, modify the entire list of elements and do not modify the individual elements of the list.

Various modifications may be applied to the present embodiments, and particular embodiments will be illustrated in the drawings and described in the detailed description section. The effect and features of the present embodiments, and a method to achieve the same, will be clearer referring to the detailed descriptions below with the drawings. However, the present embodiments may be implemented in various forms, not by being limited to the embodiments presented below.

Hereinafter, embodiments will be described in detail with reference to the accompanying drawings, and in the description with reference to the drawings, the same or corresponding constituents are indicated by the same reference numerals and redundant descriptions thereof are omitted.

In the following embodiment, it will be understood that although the terms first, second, etc. may be used herein to describe various elements, these elements should not be limited by these terms. These elements are only used to distinguish one element from another. In the following embodiment, as used herein, the singular forms “a,” “an,” and “the” are intended to include the plural forms as well, unless the context clearly indicates otherwise. In the following embodiment, it will be further understood that the terms “comprises” and/or “comprising” used herein specify the presence of stated features or elements, but do not preclude the presence or addition of one or more other features or components. Sizes of elements in the drawings may be exaggerated for convenience of explanation. For example, since sizes and shapes of components in the drawings are arbitrarily illustrated for convenience of explanation, the following embodiments are not limited thereto.

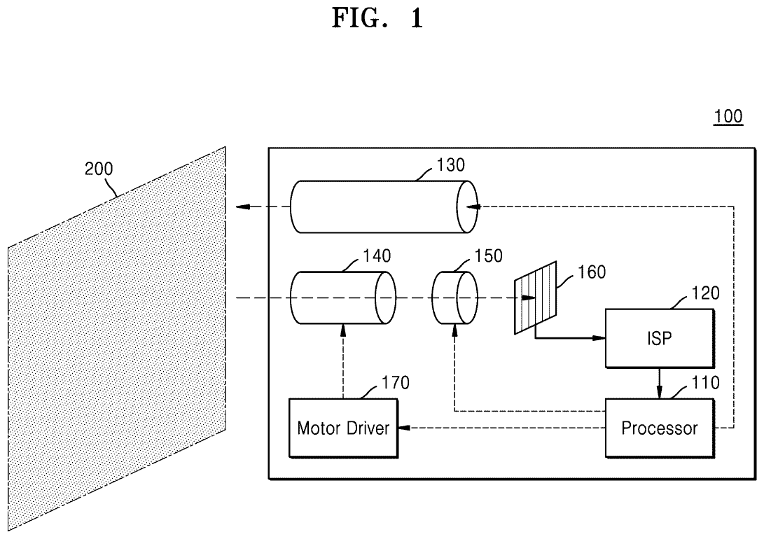

FIG. 1 is a schematic diagram showing a configuration of an image processing device 100 according to one or more example embodiments.

The image processing device 100 according to an embodiment may remove noise from an image received by the image processing device 100 or an image obtained by the image processing device 100.

The image processing device 100 according to an embodiment may include, as illustrated in FIG. 1, a processor 110, an image signal processor (ISP) 120, a light source 130, a lens group 140, a filter group 150, an image sensor 160, and a motor driver 170.

The processor 110 according to an embodiment may control components of the image processing device 100. For example, the processor 110 may drive the motor driver 170 by a user's manipulation to move the lens group 140 to an appropriate position. Furthermore, the processor 110 may perform one or more operations to remove noise from an image obtained by the image sensor 160. However, this is a mere example, and the disclosure is not limited thereto.

In the present disclosure, the “processor” may refer to a data processing device built into hardware, for example, having a physically structured circuit to perform a function expressed by a code or command included in a program. As an example of the data processing device built into hardware, the processor may include a processing device such as a microprocessor, a central processing unit (CPU), a processor core, a multiprocessor, an application-specific integrated circuit (ASIC), and a field programmable gate array (FPGA), but the scope of the present disclosure is not limited thereto.

The processor 110 may be configured with a single processor or a plurality of processors classified in units of functions performed by the processor 110.

The ISP 120 and the image sensor 160 according to an embodiment may convert light (or an optical signal) into an electrical signal. For example, the image sensor 160 may be configured with a charge coupled device (CCD) or a complementary metal-oxide-semiconductor (CMOS), and may convert light having passed through the lens group 140 and/or the filter group 150 into an electrical signal.

Furthermore, the ISP 120 may process an image (or an unprocessed RAW image) obtained by the image sensor 160 in a certain method. For example, the ISP 120 may generate a single output image by synthesizing one or more channels obtained by the image sensor 160.

In an embodiment, the processor 110 and the ISP 120 may be independently configured, as illustrated in FIG. 1, or may be integrated as one component.

The lens group 140 and the motor driver 170 according to an embodiment may perform, under control of the processor 110, an operation for adjustment of various parameters related to the image processing device 100. For example, the lens group 140 and/or the motor driver 170 according to an embodiment may adjust a position of at least one lens to adjust focus, under the control of the processor 110. In this case, the lens group 140 may include at least lens (or a single lens).

Furthermore, the lens group 140 and/or the motor driver 170 according to an embodiment may adjust a degree of opening of an aperture, under the control of the processor 110.

Furthermore, the lens group 140 and/or the motor driver 170 according to an embodiment may adjust zoom, under the control of the processor 110. However, the parameters described above are merely examples, and the disclosure is not limited thereto.

The filter group 150 according to an embodiment may be arranged between the lens group 140 and the image sensor 160 and may adjust a wavelength configuration of incident light.

The light source 130 according to an embodiment may emit light for the image processing device 100 to adjust focus for a shooting area 200. Furthermore, the light source 130 may emit light for increasing illuminance of the shooting area 200 in an image capture process. However, this is a mere example, and the disclosure is not limited thereto.

In an embodiment, the image processing device 100 may also be referred to as imaging device for description.

Although FIG. 1 illustrates that the image processing device 100 is in the form of a camera that obtains an image, the disclosure is not limited thereto. Accordingly, not only a device for obtaining an image, but also a device for transmitting and/or storing an obtained image may belong to the image processing device 100. For example, a device, such as a network video recorder (NVR) or the like, that receives and stores an image may correspond to the image processing device 100 described in the specification.

When the image processing device 100 is a device that transmits and/or stores an image, some components illustrated in FIG. 1 may not be included. For example, the image processing device 100 may not include the ISP 120, the light source 130, the lens group 140, the filter group 150, the image sensor 160, and the motor driver 170, which are components for obtaining an image.

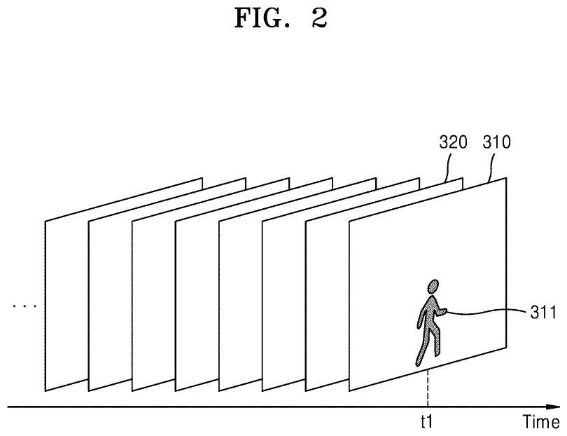

FIG. 2 is a view for describing a structure of an image processed by the image processing device 100.

As illustrated in FIG. 2, an image processed by the image processing device 100 may include a plurality of frames.

The image processing device 100 according to an embodiment may distinguish between a motion area and an area excluding the motion area in a specific frame through a comparison between frames constituting an image. For example, the image processing device 100 may distinguish a motion area and a remaining area according to a movement of an object 311 in a frame 310 through a comparison between the frame 310 and a previous frame 320. For example, the previous frame 320 may be a frame that immediately precedes the frame 310.

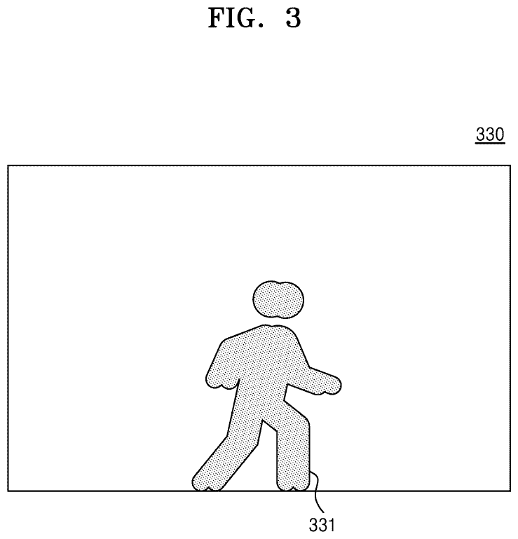

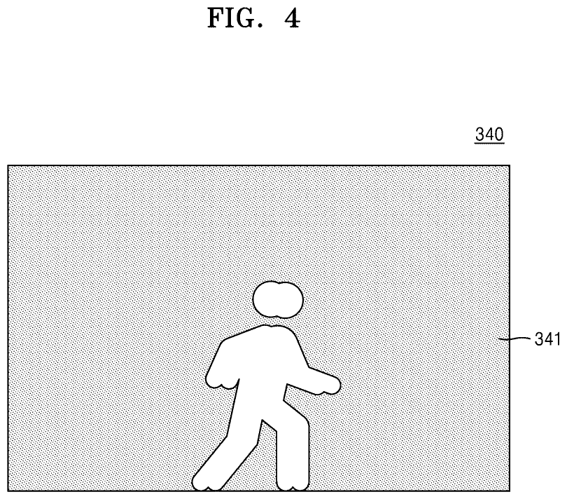

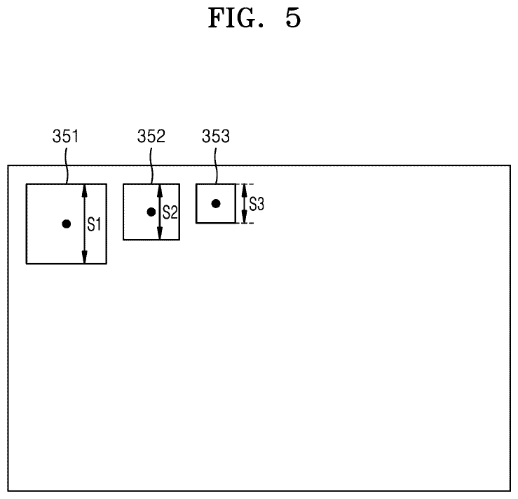

FIG. 3 illustrates an example of a motion area 331. FIG. 4 illustrates an example of a remaining area 341. FIG. 5 is a view showing sizes of masks 351, 352, and 353 used for comparing two frames according to an embodiment.

In the following description, for convenience of explanation, through the comparison between the frame 310 and the previous frame 320 in FIG. 2, it is assumed that a motion has occurred according to the movement of the object 311.

Under the assumption described above, the image processing device 100 according to an embodiment may generate the motion area 331 on a frame 330 as shown in FIG. 3. For example, the image processing device 100 may generate the motion area 331 by comparing corresponding areas between the frame 310 and the previous frame 320 in units of the mask 351 illustrated in FIG. 5. For example, the image processing device 100 may compare average properties of pixels belonging to the mask 351 at a specific position in the frame 310 with average properties of pixels belonging to the mask 351 at the same position in the previous frame 320. Furthermore, when a difference in properties between the two frames 310 and 320 is a certain threshold difference or more, the image processing device 100 may determine that the corresponding area (or a representative pixel in the corresponding area) is in a motion area. However, the above method is only an example, and the disclosure is not limited thereto.

The image processing device 100 according to an embodiment may generate a remaining area 341 on a frame 340 illustrated in FIG. 4. In an embodiment, the ‘remaining area’, which is an area excluding the motion area in a specific frame, may refer to an area where it is determined that no motion is generated.

The image processing device 100 according to an embodiment may generate the remaining area 341 in a manner of removing the motion area from an entire area of the frame 340. However, this is a mere example, and the disclosure is not limited thereto.

The image processing device 100 according to an embodiment may use masks of various sizes according to a type of a frame subject to comparison. For example, the image processing device 100 may use a mask of a largest size in first determining a motion area in an image, that is, in comparison between a first frame and a second frame in the image. For example, the image processing device 100 may use the mask 351 illustrated in FIG. 5 for detection of a motion area.

Furthermore, when comparing between a first output frame that is obtained by primarily removing noise through the comparison between the first frame and the second frame described above, with a background frame, the image processing device 100 may use a mask of a relatively small size compared with the process of comparing the first frame and the second frame described above. For example, the image processing device 100 may use the mask 352 illustrated in FIG. 5 for detection of a motion area.

Furthermore, the image processing device 100 may use a mask of a smallest size when removing noise miscorrection from a second output frame that is obtained by secondarily removing noise through the comparison between the first output frame and the background frame described above. For example, the image processing device 100 may use the mask 353 illustrated in FIG. 5 for detection of a motion area.

In FIG. 5, a size S1 of the first mask 351 is great than a size S2 of the second mask 352, and the size S2 of the second mask 352 is greater than a size S3 of the third mask 353.

However, the sizes and types of the masks are examples, and the disclosure is not limited thereto.

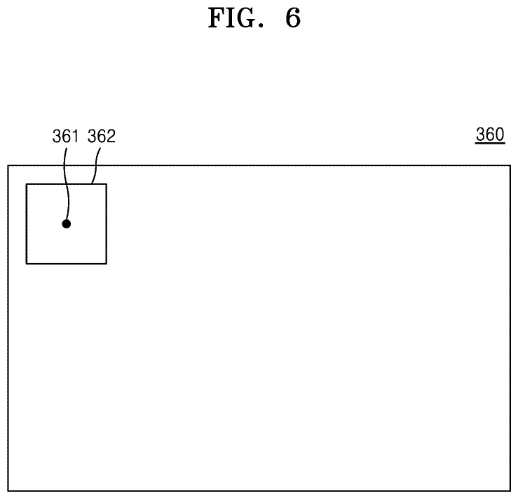

FIG. 6 is a view for explaining a first noise removing method and a third noise removing method of the image processing device 100 according to an embodiment.

In the following description, for convenience of explanation, it is assumed that a frame 360 is a target noise removal frame, and that noise needs to be removed from a target pixel 361.

The image processing device 100 according to an embodiment may remove noise by referring to only pixels in the frame 360 for at least partial area in the frame 360. For example, the image processing device 100 may remove noise from the target pixel 361 by referring to surrounding pixels 362 in the frame 360 for the target pixel 361.

For example, the image processing device 100 may remove noise in a manner of appropriately adjusting a value of the target pixel 361 by referring to a value(s) of the surrounding pixels 362. However, this is an example, and the disclosure is not limited thereto.

According to the noise removing method described above, it may be advantageous that noise removing is not affected by a passage of time with respect to an object in the image because only pixels of a corresponding frame are used for noise removal.

In a process described below, the above noise removing method may be referred to as the first noise removing method or the third noise removing method for description.

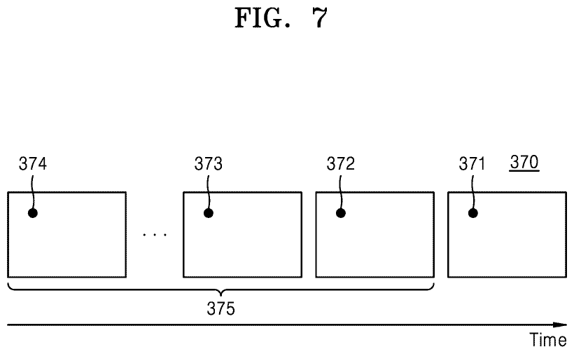

FIG. 7 is a view for explaining a second noise removing method and a fourth noise removing method of the image processing device according to an embodiment.

In the following description, for convenience of explanation, it is assume that a frame 370 is a target noise removal frame, and that noise needs to be removed from a target pixel 371.

The image processing device 100 according to an embodiment may remove noise from the target pixel 371 based on pixels 372, 373, and 374, corresponding to the target pixel 371 on the target frame 370, in at least one frame 375 before the target frame 370. The at least one frame 375 may include a frame that is immediately before the target frame 370.

For example, the image processing device 100 may remove noise in a manner of appropriately adjusting a value of the target pixel 371 by referring to values of the pixels 372, 373, and 374, corresponding to the target pixel 371 on the target frame 370, in the at least one frame 375 before the target frame 370. In this operation, the image processing device 100 according to an embodiment may apply different weights to the pixels 372, 373, and 374 considering a time point of the at least one frame 375 relative to the target frame 370. For example, the image processing device 100 may apply a higher weight to a newer pixel and a lower weight to an older pixel. Alternatively, the image processing device 100 may apply a higher weight to an older pixel and a lower weight to a newer pixel. However, this is an example, and the disclosure is not limited thereto.

According to the noise removing method described above, it may be advantageous that a clear frame may be generated by using accumulated pixel values.

In a process described below, the above noise removing method may be referred to as the second noise removing method or the fourth noise removing method for description.

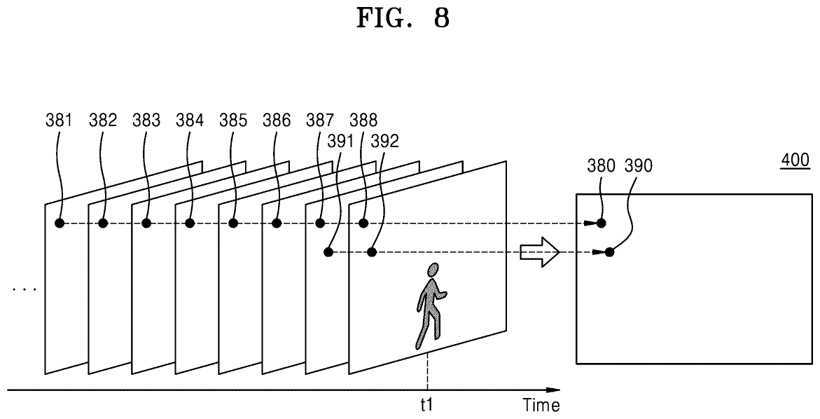

FIG. 8 is a view for explaining a process, performed by the image processing device 100, of generating an accumulated frame 400, according to an embodiment.

In the following description, for convenience of explanation, it is assumed that the accumulated frame 400 is generated based on a first time point t1.

The image processing device 100 according to an embodiment may generate the accumulated frame 400 by accumulating a plurality of frames.

For example, the image processing device 100 according to an embodiment may generate the accumulated frame 400 by applying a weight to a pixel at an individual time point from a time point when, for each individual pixel, a corresponding pixel was last included in the motion area before the first time point t1, to the first time point t1, to accumulate pixels.

For example, for a pixel 380 of the accumulated frame 400, the image processing device 100 may generate the accumulated frame 400 by accumulating pixels from a time point when the pixel 380 was last included in the motion area to the first time point t1 and applying a weight to a pixel for each time point. Accordingly, the image processing device 100 may generate the pixel 380 by applying a weight to each of pixels 381 to 388. For example, the image processing device 100 may apply a higher weight to a newer pixel and a lower weight to an older pixel. Alternatively, the image processing device 100 may apply a higher weight to an older pixel and a lower weight to a newer pixel. However, this is an example, and the disclosure is not limited thereto.

Similarly, for a pixel 390 of the accumulated frame 400, the image processing device 100 may generate the pixel 390 by applying a weight to each of pixels 391 to 392.

The accumulated frame 400 generated according to the process described above may be used for removing noise from an image, and for generating a background frame. This is described below in detail.

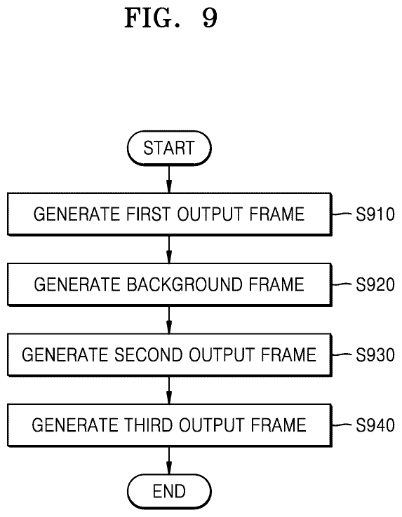

FIG. 9 is a flowchart for explaining a method used by the image processing device 100 to remove noise from an image, according to an embodiment. In the following description, the method is described with reference to FIGS. 2 to 8 together.

The image processing device 100 according to an embodiment may generate a first output frame by removing noise from a first motion area that is a motion area in a first frame according to a first noise removing method, and removing noise from a first remaining area obtained by excluding the first motion area in the first frame according to a second noise removing method (S910). In this operation, the first motion area may be determined based on a comparison between a first frame and a second frame that is a frame before the first frame.

In an embodiment, the image processing device 100 according to an embodiment may determine the first motion area as illustrated in FIG. 3 and the first remaining area as illustrated in FIG. 4, based on the comparison between the first frame and the second frame.

In an embodiment, in the comparison of two frames, the image processing device 100 according to an embodiment may determine the first motion area and the first remaining area by using, for example, the mask 351 of the largest size illustrated in FIG. 5.

Then, the image processing device 100 according to an embodiment may remove noise from a first target pixel by referring to surrounding pixels of the first target pixel in the first frame for the first motion area. For example, the image processing device 100 according to an embodiment may remove noise from the first motion area, according to the noise removing method described with reference to FIG. 6.

The image processing device 100 according to an embodiment, for example as illustrated in FIG. 7, may remove, for the first remaining area, noise from a second target pixel based on a pixel, corresponding to the second target pixel in the first frame, in at least one frame before the first frame.

In detail, the image processing device 100 according to an embodiment, for example as illustrated in FIG. 8, may generate a first accumulated frame by applying a weight to a pixel at an individual time point and accumulating pixels from a time point when, for each individual pixel, a corresponding pixel was last included in the motion area before a first time point, to the first time point. In this case, the first time point may correspond to the first frame.

Furthermore, the image processing device 100 according to an embodiment may remove noise from the second target pixel by referring to the generated first accumulated frame. For example, the image processing device 100 may generate an accumulated frame by applying a weight to a pixel at an individual time point and accumulating pixels from a time point when, for each individual pixel, a corresponding pixel was last included in the motion area before the first time point, to the first time point.

The image processing device 100 according to an embodiment may generate a background frame (S920).

The image processing device 100 according to an embodiment may determine, as a background pixel, a pixel having a number of accumulated frames that is a certain threshold value or greater, among pixels constituting the first accumulated frame generated in operation S910. For example, the image processing device 100 may determine a pixel accumulated for 50 frames or more, as a background pixel.

The image processing device 100 according to an embodiment may generate a background frame based on a background pixel to be determined according to the process described above. The generated background frame may be used in a process of generating a second output frame in operation S930 described below.

The image processing device 100 according to an embodiment may generate a second output frame by removing noise from a second motion area that is a motion area in the first output frame according to a third noise removing method, and removing noise from a second remaining area obtained by excluding the second motion area in the first output frame according to a fourth noise removing method (S930). In this case, the second motion area may be determined based on a comparison between the first output frame and the background frame.

In detail, the image processing device 100 according to an embodiment may determine the second motion area as illustrated in FIG. 3 and the second remaining area as illustrated in FIG. 4 based on a comparison between the first output frame generated in operation S910 and the background frame generated in operation S920. In the comparison of two frames, the image processing device 100 according to an embodiment may determine the second motion area and the second remaining area by using, for example, the mask 352 of a medium size illustrated in FIG. 5.

Furthermore, the image processing device 100 according to an embodiment may remove noise from a third target pixel in the second motion area of the first output frame by referring to surrounding pixels of the third target pixel. For example, the image processing device 100 according to an embodiment may remove noise from the second motion area according to the noise removing method described with reference to FIG. 6.

The image processing device 100 according to an embodiment may remove noise from a fourth target pixel in the second remaining area of the first output frame by referring to a pixel, corresponding to the fourth target pixel, in the background frame. For example, the image processing device 100 may remove noise in a manner of correcting a value of the fourth target pixel by referring to a value of the pixel corresponding to the fourth target pixel in the background frame. However, such a manner is a mere example, and the disclosure is not limited thereto.

The image processing device 100 according to an embodiment may generate a third output frame by removing noise miscorrection based on a comparison result between the second output frame generated in operation S930 and the first output frame generated in operation S910 (S940).

In detail, the image processing device 100 according to an embodiment may compare the second output frame with the first output frame and determine an outlier area in the second output frame in which a difference between the first and second output frames is greater than or equal to a threshold difference, and may determine a third remaining area in the second output frame that is obtained by excluding the outlier area from the second output frame. In the comparison between the two output frames, the image processing device 100 according to an embodiment may determine the outlier area and the third remaining area by using, for example, the mask 353 of the smallest size illustrated in FIG. 5.

The image processing device 100 according to an embodiment may generate an area, corresponding to the third remaining area, of the third output frame based on the second output frame. For example, the image processing device 100 may generate the third output frame by using an area corresponding to the third remaining area in the second output frame.

The image processing device 100 according to an embodiment may generate an area, corresponding to the outlier area, of the third output frame based on the first output frame. For example, the image processing device 100 may generate the third output frame by using an area corresponding to the outlier area in the first output frame.

Thus, according to the disclosure, an image in which noise generated according to the motion of an object is reduced may be generated.

The example embodiments according to the disclosure described above may be implemented in the form of a computer program that may be executed through various components on a computer, and such a computer program may be recorded on a computer-readable medium The computer-readable medium may include, for example but not limited to, a magnetic medium, such as a hard disk, a floppy disk, and a magnetic tape, an optical recording medium, such as a compact disc (CD)-read only memory (ROM) and a digital versatile disc (DVD), a magneto-optical medium, such as floptical disks, and a hardware device such as a ROM, a RAM, a flash memory, or the like, which is specifically configured to store and execute program instructions. Furthermore, the computer-readable medium may include intangible medium implemented to be capable of transmitting on a network. For example, the medium may be implemented in the form of software or application so as to be transmitted and distributed via a network.

The computer program may be specially designed and configured for the disclosure or may be known to one skilled in the art of computer software, to be usable. An example of a computer program may include not only machine codes created by a compiler but also high-level programming language executable by a computer using an interpreter.

The particular implementations shown and described herein are illustrative examples of the disclosure and are not intended to otherwise limit the scope of the disclosure in any way. For the sake of brevity, related art electronics, control systems, software development and other functional aspects of the systems may not be described in detail. Furthermore, connecting lines, or connectors shown in the various figures presented are intended to represent functional relationships and/or physical or logical couplings between the various elements. It should be noted that many alternative or additional functional relationships, physical connections or logical connections may be present in a practical device. Moreover, no item or component is essential to the practice of the disclosure unless the element is specifically described as “essential” or “critical.”

According to the disclosure, image quality deterioration caused by noise trailing particularly in a low illuminance environment may be effectively improved.

It should be understood that embodiments described herein should be considered in a descriptive sense only and not for purposes of limitation. Descriptions of features or aspects within each embodiment should typically be considered as available for other similar features or aspects in other embodiments.

While one or more example embodiments have been described with reference to the figures, it will be understood by those of ordinary skill in the art that various changes in form and details may be made therein without departing from the spirit and scope of the disclosure as defined by the following claims and their equivalents.

What is claimed is:

1. A method of removing noise from an image, the method comprising:
generating a first output frame by removing a noise from a first motion area in a first frame, and removing a noise from a first remaining area, obtained by excluding the first motion area from the first frame, wherein the first motion area is determined based on a comparison between the first frame and a second frame that is a frame before the first frame; and
generating a second output frame by removing a noise from a second motion area in the first output frame, and removing a noise from a second remaining area, obtained by excluding the second motion area from the first output frame, wherein the second motion area is determined based on a comparison between the first output frame and a background frame.

2. The method of claim 1, wherein the generating the first output frame comprises:
determining the first motion area and the first remaining area based on the comparison between the first frame and the second frame;
removing a noise from a first target pixel in the first motion area based on at least one surrounding pixel of the first target pixel in the first frame; and
removing a noise from a second target pixel in the first remaining area based on at least one pixel, corresponding to the second target pixel in the first frame, in at least one frame before the first frame.

3. The method of claim 2, wherein the removing the noise from the second target pixel comprises:
generating a first accumulated frame by applying a weight to each of the at least one pixel in the at least one frame before the first frame at each individual time point and accumulating pixels from a time point when, for each individual pixel, a corresponding pixel was last included in a motion area before a first time point, to the first time point, the first time point corresponding to the first frame; and
removing a noise from the second target pixel based on the first accumulated frame.

4. The method of claim 3, further comprising, after the generating the first output frame:
generating the background frame based on the first accumulated frame,
wherein the generating the background frame comprises:
determining, as a background pixel, at least one pixel having a number of accumulated frames that is a certain threshold value or greater, among pixels constituting the first accumulated frame; and
generating the background frame based on the at least one background pixel.

5. The method of claim 1, wherein the generating the second output frame comprises:
determining the second motion area and the second remaining area based on the comparison between the first output frame and the background frame;
removing a noise from a third target pixel in the second motion area based on at least one surrounding pixel of the third target pixel in the first output frame; and
removing a noise from a fourth target pixel in the second remaining area based on a pixel, corresponding to the fourth target pixel in the first output frame, in the background frame.

6. The method of claim 1, further comprising, after the generating the second output frame:
generating a third output frame by removing a noise miscorrection based on a comparison result between the second output frame and the first output frame.

7. The method of claim 6, wherein the generating the third output frame comprises:
comparing the second output frame with the first output frame and determining an outlier area in which a difference between the second output frame and the first output frame is greater than or equal to a threshold, and determining a third remaining area obtained by excluding the outlier area from the second output frame;
generating an area corresponding to the third remaining area of the third output frame based on the second output frame; and
generating an area corresponding to the outlier area of the third output frame based on the first output frame.

8. The method of claim 1, wherein a mask of a first size is used for the comparison between the first frame and the second frame,
wherein a mask of a second size is used for the comparison between the first output frame and the background frame, and
wherein the first size is larger than the second size.

9. The method of claim 7, wherein a mask of a first size is used for the comparison between the first frame and the second frame,
wherein a mask of a second size is used for the comparison between the first output frame and the background frame,
wherein a mask of a third size is used for the comparison between the first output frame and the second output frame, and
wherein the first size is larger than the second size, and the second size is larger than the third size.

10. The method of claim 1, wherein the noise is removed from the first motion area or the second motion area by using at least one pixel in in the first frame or the first output frame, and
wherein the noise is removed from the first remaining area or the second remaining area by using at least one pixel in an accumulated frame generated by accumulating pixels of at least one previous frame of the first frame and the first frame.

11. A non-transitory computer-readable medium storing a computer program, wherein the computer program, when executed by at least one processor, causes the at least one processor to perform:
generating a first output frame by a removing noise from a first motion area in a first frame, and removing a noise from a first remaining area, obtained by excluding the first motion area from the first frame, wherein the first motion area is determined based on a comparison between the first frame and a second frame that is a frame before the first frame; and
generating a second output frame by removing a noise from a second motion area in the first output frame, and removing a noise from a second remaining area, obtained by excluding the second motion area from the first output frame, wherein the second motion area is determined based on a comparison between the first output frame and a background frame.

12. An image processing device comprising at least one processor, wherein the at least one processor is configured to:
generate a first output frame by removing a noise from a first motion area in a first frame, and removing a noise from a first remaining area, obtained by excluding the first motion area from the first frame, wherein the first motion area is determined based on a comparison between the first frame and a second frame that is a frame before the first frame; and
generate a second output frame by removing a noise from a second motion area in the first output frame, and removing a noise from a second remaining area, obtained by excluding the second motion area from the first output frame, wherein the second motion area is determined based on a comparison between the first output frame and a background frame.

13. The image processing device of claim 12, wherein the at least one processor is further configured to, in generating the first output frame:
determine the first motion area and the first remaining area based on the comparison between the first frame and the second frame;
remove a noise from a first target pixel in the first motion area based on at least one surrounding pixel of the first target pixel in the first frame; and
remove a noise from a second target pixel in the first remaining area based on at least one pixel, corresponding to the second target pixel in the first frame, in at least one frame before the first frame.

14. The image processing device of claim 13, wherein the at least one processor is further configured to, in the removing of noise from the second target pixel:
generate a first accumulated frame by applying a weight to each of the at least one pixel in the at least one frame before the first frame at each individual time point and accumulating pixels from a time point when, for each individual pixel, a corresponding pixel was last included in a motion area before a first time point, to the first time point, the first time point corresponding to the first frame; and
remove a noise from the second target pixel based on the first accumulated frame.

15. The image processing device of claim 14, wherein while the at least one processor is further configured to generate the background frame based on the first accumulated frame, among pixels constituting the first accumulated frame, at least one pixel having a number of accumulated frames that is a certain threshold value or greater is determined as a background pixel, and the background frame is generated based on the at least one background pixel.

16. The image processing device of claim 12, wherein the at least one processor is further configured to, in the generating of the second output frame:
determine the second motion area and the second remaining area based on the comparison between the first output frame and the background frame;
remove a noise from a third target pixel in the second motion area based on at least one surrounding pixel of the third target pixel in the first output frame; and
remove a noise from a fourth target pixel in the second remaining area based on a pixel, corresponding to the fourth target pixel in the first output frame, in the background frame.

17. The image processing device of claim 12, wherein the at least one processor is further configured to generate a third output frame by removing a noise miscorrection based on a comparison result between the second output frame and the first output frame.

18. The image processing device of claim 17, wherein the at least one processor is further configured to, in generating the third output frame:
compare the second output frame with the first output frame and determine an outlier area in which a difference between the second output frame and the first output frame is greater than or equal to a threshold, and determine a third remaining area obtained by excluding the outlier area from the second output frame;
generate an area corresponding to the third remaining area of the third output frame based on the second output frame; and
generate an area corresponding to the outlier area of the third output frame based on the first output frame.

19. The image processing device of claim 18, wherein a mask of a first size is used for the comparison between the first frame and the second frame,
wherein a mask of a second size is used for the comparison between the first output frame and the background frame,
wherein a mask of a third size is used for the comparison between the first output frame and the second output frame, and
wherein the first size is larger than the second size, and the second size is larger than the third size.

20. The image processing device of claim 12, wherein the at least one processor is configured to:
remove the noise from the first motion area or the second motion area by using at least one pixel in in the first frame or the first output frame, and
remove the noise from the first remaining area or the second remaining area by using at least one pixel in an accumulated frame generated by accumulating pixels of at least one previous frame of the first frame and the first frame.
